(19) United States
(12) Patent Application Publication
(10) Pub. No.: US 2021/0364970 A1
(43) Pub. Date: Nov. 25, 2021

(54) IMAGE FORMING APPARATUS

(71) Applicant: CANON KABUSHIKI KAISHA, Tokyo (JP)

(72) Inventor: Kengo Sato, Saitama (JP)

(21) Appl. No.: 17/320,864

(22) Filed: May 14, 2021

(30) Foreign Application Priority Data
May 19, 2020 (JP) 2020-087087

(51) Int. Cl. G03G 15/00

(52) U.S. Cl. CPC G03G 15/6529

(57) ABSTRACT

An image forming apparatus includes a fixing portion, a first belt conveyance portion having a first conveyance belt with a first conveyance surface, and a first air suction portion having a first opening portion, includes a second belt conveyance portion having a second conveyance belt with a second conveyance surface, and a second air suction portion having a second opening portion, and includes a pre-fixation guide portion having a guide surface that guides a leading end of a sheet conveyed on the second conveyance surface toward the fixing portion. As viewed in a sheet width direction, a center position of the first opening portion is disposed at approximately the same position as a center position of the first conveyance surface, and a center position of the second opening portion is disposed at a position closer to the pre-fixation guide portion than a center position of the second conveyance surface.

### BACKGROUND

### Field

The present disclosure relates to an image forming apparatus that forms an image on a sheet.

### Description of the Related Art

Conventionally, an image forming apparatus of an electrophotographic system including a transfer unit that transfers a toner image onto a sheet and a fixing unit including a fixing nip portion in which the transferred toner image is fixed to the sheet is known.

As such an image forming apparatus, Japanese Patent Laid-Open No. 2012-83416 discloses a configuration including a belt conveyance portion that conveys the sheet from a transfer unit to a fixing unit while sucking air to attract the sheet onto the circumferential surface of a belt. A plurality of belt conveyance portions are provided in a sheet conveyance direction, and a pre-fixation guide that guides the sheet to the nip portion of the fixing unit is provided between a belt conveyance portion on the downstream side and the fixing unit.

In recent years, more kinds of sheets have become applicable to an image forming apparatus. Examples of the sheets include sheets of small sizes and high rigidity such as postcards and other cards. In the case of conveying sheets of these kinds by the belt conveyance portions, there is a risk that the sheet is nipped by neither of the transfer unit and the fixing unit and therefore the sheet cannot be conveyed up on the inclined surface of the pre-fixation guide.

### SUMMARY

The present disclosure provides an image forming apparatus that can convey sheets of small sizes and high rigidity by a belt conveyance portion.

According to an aspect of the present disclosure, an image forming apparatus includes an image bearing member configured to bear a toner image, a transfer portion configured to transfer the toner image born on the image bearing member onto a sheet, a fixing portion configured to fix, to the sheet, the toner image transferred onto the sheet by the transfer portion, a first belt conveyance portion disposed between the transfer portion and the fixing portion in a sheet conveyance direction, wherein the first belt conveyance portion includes a first stretching portion, a first air suction portion having a first opening portion, and a first conveyance belt having an endless shape and breathability, wherein the first stretching portion is configured to rotatably stretch the first conveyance belt to form a first conveyance surface on which the sheet is to be conveyed, wherein the first air suction portion includes a first opening portion open toward the first conveyance surface and provided on a side opposite to the first conveyance surface, wherein the first air suction portion is configured to suck air through the first opening portion to attract the sheet to the first conveyance surface of the first conveyance belt, and wherein the first belt conveyance portion is configured to convey the sheet by rotating the first conveyance belt while sucking air by the first air suction portion to attract the sheet, a second belt conveyance portion disposed between the first belt conveyance portion and the fixing portion in the sheet conveyance direction, wherein the second belt conveyance portion includes a second stretching portion, a second air suction portion having a second opening portion, and a second conveyance belt having an endless shape and breathability, wherein the second stretching portion is configured to rotatably stretch the second conveyance belt to form a second conveyance surface on which the sheet is to be conveyed, wherein the second air suction portion includes a second opening portion open toward the second conveyance surface and provided on a side opposite to the second conveyance surface, wherein the second air suction portion is configured to suck air through the second opening portion to attract the sheet to the second conveyance surface of the second conveyance belt, and wherein the second belt conveyance portion is configured to convey the sheet by rotating the second conveyance belt while sucking air by the second air suction portion to attract the sheet, and a pre-fixation guide portion disposed between the second belt conveyance portion and the fixing portion in the sheet conveyance direction, wherein the pre-fixation guide portion includes a guide surface configured to guide a leading end of the sheet conveyed on the second conveyance surface toward the fixing portion, wherein, as viewed in a sheet width direction perpendicular to the sheet conveyance direction, a center position of the first opening portion is disposed at approximately the same position as a center position of the first conveyance surface, and a center position of the second opening portion is disposed at a position closer to the pre-fixation guide portion than a center position of the second conveyance surface.

Further features of the present disclosure will become apparent from the following description of exemplary embodiments with reference to the attached drawings.

### BRIEF DESCRIPTION OF THE DRAWINGS

FIG. 1 is a schematic configuration diagram of an image forming apparatus according to a first embodiment.

FIG. 2 is a perspective view of a belt conveyance unit according to the first embodiment illustrating a configuration thereof.

FIG. 3 is a perspective view of the belt conveyance unit according to the first embodiment from which a first conveyance belt and a second conveyance belt have been removed.

FIG. 4 is a diagram illustrating an example of a cross-section of a first belt conveyance portion according to the first embodiment.

FIG. 5 is a diagram illustrating an example of a cross-section of a second belt conveyance portion according to the first embodiment.

FIG. 6 is a section view of a second transfer portion, a belt conveyance unit, and a fixing portion according to the first embodiment.

FIG. 7 is a section view of the second transfer portion, the belt conveyance unit, and the fixing portion according to the first embodiment.

FIG. 8 is a section view of the second transfer portion, the belt conveyance unit, and the fixing portion according to the first embodiment.

FIG. 9 is a functional block diagram illustrating a control configuration of the image forming apparatus according to the first embodiment.

FIG. 10 is a diagram illustrating an example of a distribution of suction force on a conveyed surface of the sheet according to the first embodiment.

### DESCRIPTION OF THE EMBODIMENTS

Exemplary embodiments of the present disclosure will be described below with reference to drawings.

### First Embodiment

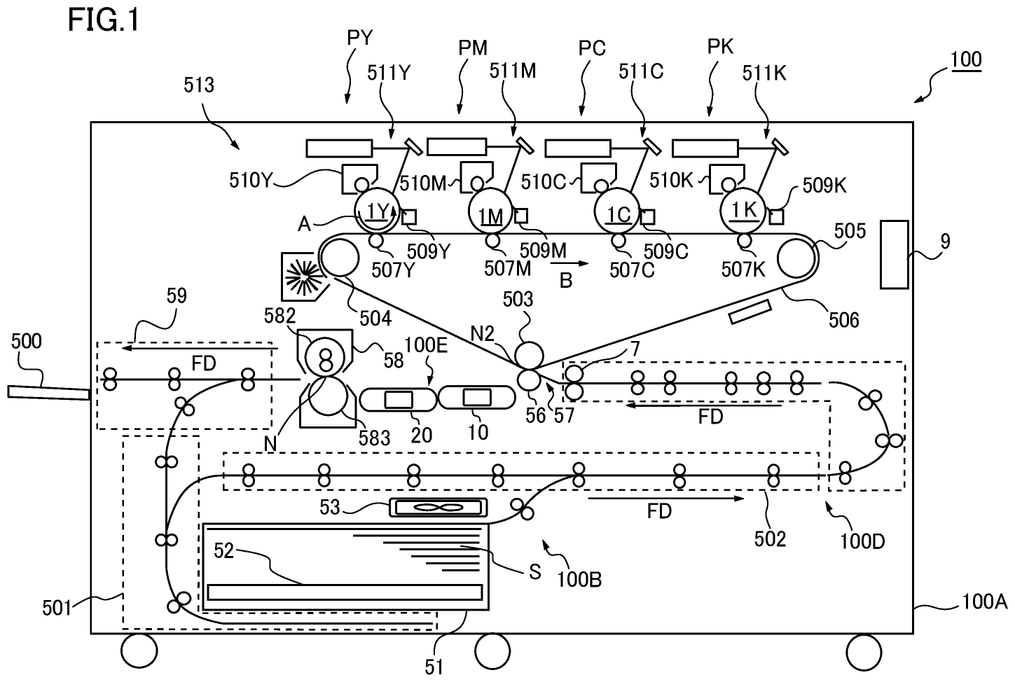

FIG. 1 is a schematic configuration diagram of an image forming apparatus 100 according to a first embodiment. First, a configuration of the image forming apparatus 100 will be described with reference to FIG. 1. The image forming apparatus 100 includes a feeding portion 100B that feeds a sheet, and a sheet conveyance portion 100D that conveys the sheet fed by the feeding portion 100B. In addition, the image forming apparatus 100 includes an image forming portion 513 that forms a toner image that is to be fixed to the sheet, a secondary transfer portion 57 that transfers the toner image onto the sheet, and a belt conveyance unit 100E that conveys the sheet onto which the toner image has been transferred to a fixing portion 58. Further, the image forming apparatus 100 includes a post-conveyance portion 59 that conveys the sheet to which the toner image has been fixed by the fixing portion 58. The feeding portion 100B includes a sheet cassette 51 that accommodates sheets on a lift-up unit 52, and a sheet feeding unit 53 that delivers out a sheet S accommodated in the sheet cassette 51. Examples of the sheet feeding method by the sheet feeding unit 53 include a friction separation method using a roller and a separation suction method using air. FIG. 1 illustrates an example using a separation suction method using air. To be noted, a configuration in which the sheet is fed by the friction separation method using a roller in the image forming apparatus 100 may be employed. The sheet fed from the feeding portion 100B is sequentially passed onto each of a plurality of roller pairs provided in the sheet conveyance portion 100D, and is thus conveyed to the secondary transfer portion 57.

The image forming portion 513 is an image forming unit of a so-called tandem type in which image forming stations PY, PM, PC, and PK of an electrophotographic system that respectively form toner images of yellow, magenta, cyan, and black are arranged in series. The image forming stations PY, PM, PC, and PK all have the same configuration except for the color of toner therein. Therefore, the configuration of the image forming station PY will be described as an example, and description of the image forming stations PM, PC, and PK will be omitted. To be noted, In FIG. 1, elements of the image forming station PY are denoted with a suffix “Y”, elements of the image forming station PM are denoted with a suffix “M”, elements of the image forming station PC are denoted with a suffix “C”, and elements of the image forming station PK are denoted with a suffix “K”. The image forming station PY includes a photosensitive drum 1Y, an exposing unit 511Y, a developing unit 510Y, a primary transfer unit 507Y, and a cleaner 509Y. The image forming portion 513 includes an intermediate transfer belt 506 serving as an example of an image bearing member that bears toner images visualized by the image forming stations PY, PM, PC, and PK. The intermediate transfer belt 506 is supported in the state of being stretched over a driving roller 505, a tension roller 504, and a transfer inner roller 503, and rotates in an arrow B direction of FIG. 1 by being driven by the driving roller 505.

The secondary transfer roller 56 is in pressure contact with the intermediate transfer belt 506 supported by the transfer inner roller 503 disposed in the space enclosed by the intermediate transfer belt 506, and thus forms a secondary transfer nip portion N2 between the secondary transfer roller 56 and the intermediate transfer belt 506. The secondary transfer roller 56, the intermediate transfer belt 506, and the transfer inner roller 503 constitute the secondary transfer portion 57 serving as a transfer portion of the present embodiment. Transfer residual toner, paper dust, and the like remaining on the surface of the intermediate transfer belt 506 after the sheet passes through the secondary transfer nip portion N2 are removed by an unillustrated cleaning unit. The fixing portion 58 disposed downstream of the secondary transfer portion 57 in a sheet conveyance direction FD is a fixing unit that fixes a toner image to a sheet by heat and pressure. The fixing portion 58 includes a heating roller 582 including a heater therein, and an opposing roller 583 that is disposed to be able to abut the heating roller 582 so as to form a fixing nip portion N with the heating roller 582. In addition, the fixing portion 58 includes an unillustrated heating roller temperature sensor that detects the surface temperature of the heating roller 582, and an unillustrated pressurizing roller temperature sensor that detects the surface temperature of the opposing roller 583. The heating roller temperature sensor and the pressurizing roller temperature sensor are respectively provided for maintaining the surface temperature of the heating roller 582 and the surface temperature of the opposing roller 583 at appropriate temperatures.

The belt conveyance unit 100E is disposed between the secondary transfer portion 57 and the fixing portion 58 in the sheet conveyance direction FD. The belt conveyance unit 100E is constituted by a first belt conveyance portion 10 disposed on the upstream side in the sheet conveyance direction FD, and a second belt conveyance portion 20 disposed downstream of the first belt conveyance portion 10. The configuration of the belt conveyance unit 100E will be described later.

The post-conveyance portion 59 discharges a sheet discharged from the fixing portion 58 to a tray 500 on the outside of an apparatus body 100A of the image forming apparatus 100. The post-conveyance portion 59 further includes a reverse conveyance portion 501 that reverses and conveys the sheet, and a duplex conveyance path 502 through which the sheet reversed by the reverse conveyance portion 501 is conveyed into a sheet conveyance path of the sheet conveyance portion 100D.

Next, a process of forming an image on a sheet by the image forming apparatus 100 will be described. First, on the basis of an image forming job input to the image forming apparatus 100, the exposing unit 511Y exposes the photosensitive drum 1Y to form an electrostatic latent image on the surface of the photosensitive drum 1Y. The electrostatic latent image on the photosensitive drum 1Y is developed by the developing unit 510Y, and is thus visualized as a toner image. The toner image born on the surface of the photosensitive drum 1Y is transferred onto the intermediate transfer belt 506 by the primary transfer unit 507Y through primary transfer. Toner images born on the surface of the photosensitive drums 1Y, 1M, 1C, and 1K are sequentially transferred onto the intermediate transfer belt 506 so as to be superimposed on one another to form a full-color toner image. The toner image formed on the intermediate transfer belt 506 is transferred, through secondary transfer, onto the sheet S nipped and conveyed by the secondary transfer nip portion N2 serving as a transfer nip portion of the present embodiment. To be noted, the intermediate transfer belt 506 is rotationally driven by the driving roller 505 rotating at a constant speed, and is thus rotated while the peripheral speed thereof is maintained at a constant transfer speed. Therefore, the conveyance speed of the sheet in the secondary transfer nip portion N2 is equal to the peripheral speed of the intermediate transfer belt 506.

A registration roller 7 of the sheet conveyance portion 100D receives the sheet S in a state in which the rotation thereof is stopped, starts rotating at a timing matching the conveyance of the toner image on the intermediate transfer belt 506, and delivers out the sheet S toward the secondary transfer nip portion N2. The toner image is transferred onto the sheet S in the secondary transfer nip portion N2. The sheet S bearing the transferred toner image is conveyed from the secondary transfer nip portion N2 toward the fixing portion 58 by the belt conveyance unit 100E. In the fixing portion 58, the sheet S is nipped and conveyed by the fixing nip portion N, and heat and pressure are applied to the unfixed toner image to fix the toner image onto the sheet S. The sheet S delivered out from the fixing portion 58 is discharged to the outside of the image forming apparatus 100 by the post-conveyance portion 59.

In the case of forming an image on each surface of a sheet, the sheet delivered out from the fixing portion 58 is first conveyed to the reverse conveyance portion 501, is reversed by the reverse conveyance portion 501, and is then conveyed toward the duplex conveyance path 502. Then, the sheet is conveyed to the conveyance path of the sheet conveyance portion 100D again through the duplex conveyance path 502. A toner image is formed on a back surface of the sheet conveyed to the sheet conveyance portion 100D serving as a second surface thereof similarly to a front surface thereof serving as a first surface.

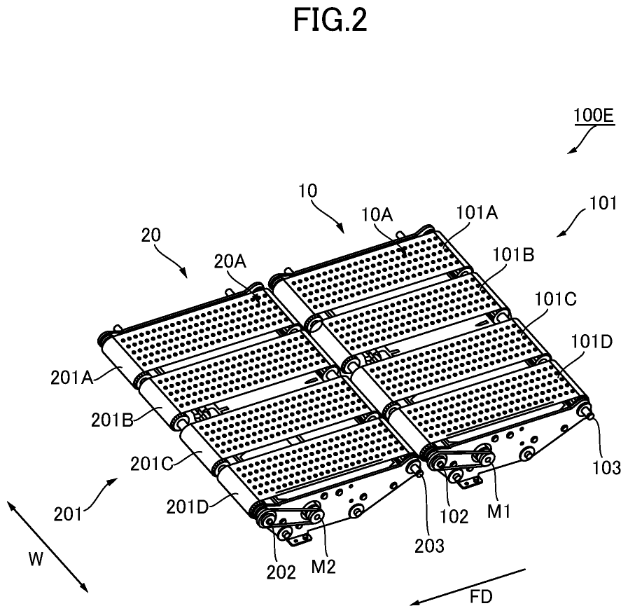

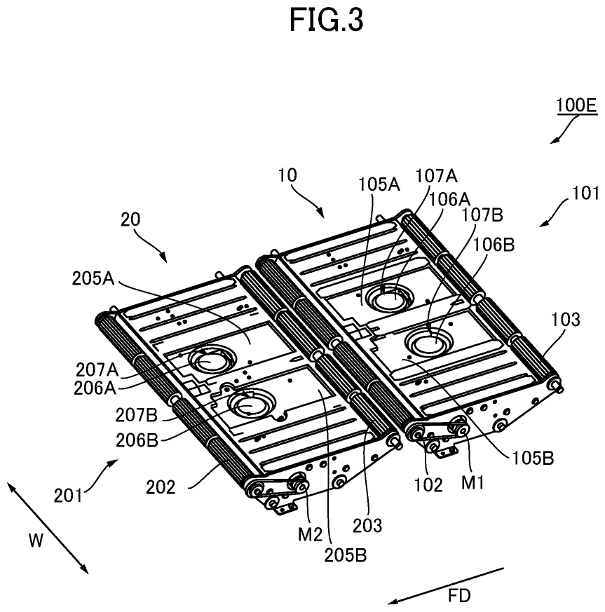

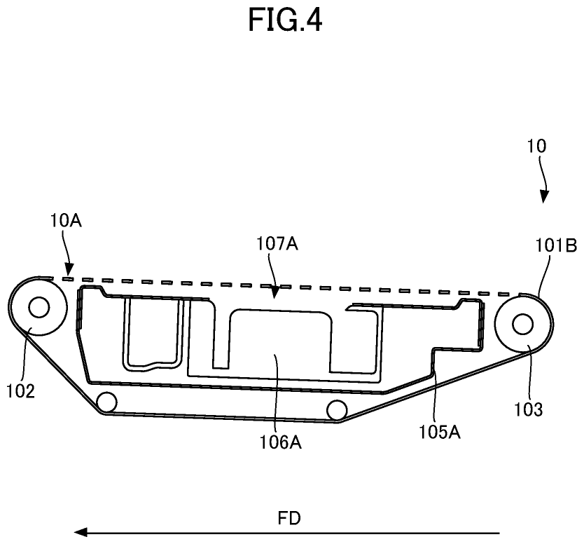

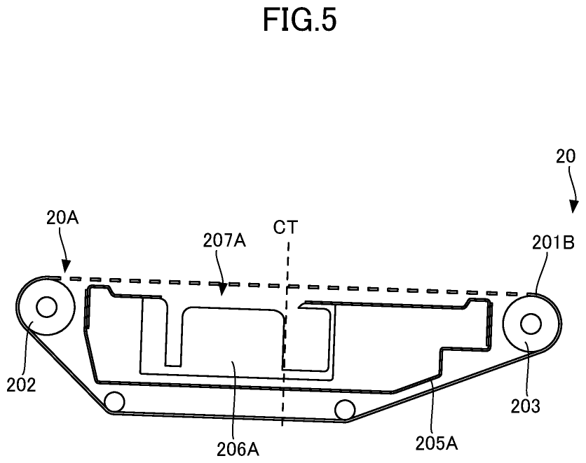

Next, details of the configuration of the belt conveyance unit 100E will be described with reference to FIGS. 2 to 5. FIG. 2 is a perspective view of the belt conveyance unit 100E illustrating a configuration thereof. FIG. 3 is a perspective view of the belt conveyance unit 100E from which a first conveyance belt 101 and a second conveyance belt 201 are removed. FIG. 4 is a diagram illustrating an example of a cross-section of a first belt conveyance portion 10. FIG. 5 is a diagram illustrating an example of a cross-section of a second belt conveyance portion 20.

The belt conveyance unit 100E is disposed between the secondary transfer portion 57 and the fixing portion 58 in the sheet conveyance direction FD, and conveys the sheet from the secondary transfer nip portion N2 toward the fixing nip portion N as illustrated in FIG. 1. The belt conveyance unit 100E includes the first belt conveyance portion 10 and the second belt conveyance portion 20 in the example of the present embodiment. The first belt conveyance portion 10 is disposed downstream of the secondary transfer nip portion N2 and the most upstream in the belt conveyance unit 100E in the sheet conveyance direction FD, and the second belt conveyance portion 20 is disposed downstream of the first belt conveyance portion 10 and upstream of the fixing nip portion N.

First, the configuration of the first belt conveyance portion 10 will be described. As illustrated in FIG. 2, the first belt conveyance portion 10 includes a first conveyance belt 101 serving as a first conveyance belt portion of the present embodiment, and rollers 102 and 103 that rotatably stretch the first conveyance belt 101. The rollers 102 and 103 are first stretching portions of the present embodiment. In addition, the first belt conveyance portion 10 includes a motor M1 that rotates the roller 102 to rotate the first conveyance belt 101. In addition, the first conveyance belt 101 is constituted by belts 101A, 101B, 101C, and 101D. The belts 101A, 101B, 101C, and 101D are each an endless belt provided with numerous holes therein, and are therefore breathable such that air can be communicated between the inner circumferential surface and the outer circumferential surface of the first conveyance belt 101 through the holes. The belts 101A, 101B, 101C, and 101D make up a conveyance surface 10A of the first conveyance belt 101 on which the sheet is conveyed. The conveyance surface 10A is a first conveyance surface of the present embodiment. In addition, the belts 101A, 101B, 101C, and 101D are arranged with intervals therebetween in a width direction W perpendicular to the sheet conveyance direction FD. Further, as illustrated in FIG. 3, fans 106A and 106B for attracting the sheet to the conveyance surface 10A are provided on the inner circumferential surface side of the first conveyance belt 101. The fans 106A and 106B are respectively disposed in ducts 105A and 105B in which opening portions 107A and 107B serving as passage paths for air sucked by the fans 106A and 106B are respectively provided.

Here, the layout of the fans 106A and 106B and the ducts 105A and 105B in the first belt conveyance portion 10 will be described with reference to FIG. 4. To be noted, FIG. 4 illustrates a cross-section of the first belt conveyance portion 10 taken at a position overlapping with the belt 101B as viewed in the width direction W of FIG. 2. The duct 105A provided with the fan 106A is provided at a position overlapping with the belt 101B in the width direction W in the first belt conveyance portion 10. The fan 106A sucks air from the outer circumferential surface side to the inner circumferential surface side of the first conveyance belt 101 through the opening portion 107A provided in the duct 105A. The opening portion 107A is defined so as to open toward the conveyance surface 10A from the inside of the first conveyance belt 101. In addition, the opening portion 107A is disposed at the center of the conveyance surface 10A in the conveyance direction FD. When the fan 106A is driven, air is sucked into the duct 105A through the opening portion 107A, and thus the sheet conveyed on the first conveyance belt 101 is attracted to the conveyance surface 10A. To be noted, the duct 105B, the fan 106B, and the opening portion 107B are configured in the same manner as the duct 105A, the fan 106A, and the opening portion 107A except for being disposed at positions overlapping with the belt 101C in the width direction W of FIG. 2, and therefore description thereof will be omitted. The fans 106A and 106B that are capable of attracting the sheet to the conveyance surface 10A are first air suction portions of the present embodiment, and the opening portions 107A and 107B are examples of first opening portions of the present embodiment.

Next, a configuration of the second belt conveyance portion 20 will be described. As illustrated in FIG. 2, the second belt conveyance portion 20 includes a second conveyance belt 201 serving as a second conveyance belt portion of the present embodiment, and rollers 202 and 203 that rotatably stretch the second conveyance belt 201. The rollers 202 and 203 are second stretching portions of the present embodiment. In addition, the second belt conveyance portion 20 includes a motor M2 that rotates the roller 202 to rotate the second conveyance belt 201. In addition, the second conveyance belt 201 is constituted by belts 201A, 201B, 201C, and 201D. The belts 201A, 201B, 201C, and 201D are each an endless belt provided with numerous holes therein, and are therefore breathable such that air can be communicated between the inner circumferential surface and the outer circumferential surface of the second conveyance belt 201 through the holes. The belts 201A, 201B, 201C, and 201D make up a conveyance surface 20A of the second conveyance belt 201 on which the sheet is conveyed. The conveyance surface 20A is a second conveyance surface of the present embodiment. In addition, the belts 201A, 201B, 201C, and 201D are arranged with intervals therebetween in the width direction W perpendicular to the sheet conveyance direction FD. Further, as illustrated in FIG. 3, fans 206A and 206B for attracting the sheet to the conveyance surface 20A are provided on the inner circumferential surface side of the second conveyance belt 201. The fans 206A and 206B are respectively disposed in ducts 205A and 205B in which opening portions 207A and 207B serving as passage paths for air sucked by the fans 206A and 206B are respectively provided.

Here, the layout of the fans 206A and 206B and the ducts 205A and 205B in the second belt conveyance portion 20 will be described with reference to FIG. 5. To be noted, FIG. 5 illustrates a cross-section of the second belt conveyance portion 20 taken at a position overlapping with the belt 201B as viewed in the width direction W of FIG. 2. The duct 205A provided with the fan 206A is provided at a position overlapping with the belt 201B in the width direction W in the second belt conveyance portion 20. The fan 206A sucks air from the outer circumferential surface side to the inner circumferential surface side of the second conveyance belt 201 through the opening portion 207A provided in the duct 205A. The opening portion 207A is defined so as to open toward the conveyance surface 20A from the inside of the second conveyance belt 201. In addition, the center of the opening portion 207A is disposed downstream of the center of the conveyance surface 20A in the conveyance direction FD. When the fan 206A is driven, air is sucked into the duct 205A through the opening portion 207A, and thus the sheet conveyed on the second conveyance belt 201 is attracted to the conveyance surface 20A. To be noted, the duct 205B, the fan 206B, and the opening portion 207B are configured in the same manner as the duct 205A, the fan 206A, and the opening portion 207A except for being disposed at positions overlapping with the belt 201C in the width direction W of FIG. 2, and therefore description thereof will be omitted. The fans 206A and 206B that are capable of attracting the sheet to the conveyance surface 20A are second air suction portions of the present embodiment, and the opening portions 207A and 207B are examples of second opening portions of the present embodiment.

As described above, the centers of the opening portions 207A and 207B of the second belt conveyance portion 20 disposed the most downstream in the conveyance direction FD in the belt conveyance unit 100E are disposed downstream of the center of the second conveyance surface 20A in the conveyance direction FD as viewed in the width direction W. In addition, the first opening portions 107A and 107B of the first belt conveyance portion 10 disposed upstream of and adjacent to the second belt conveyance portion 20 in the conveyance direction FD are disposed at the center of the first conveyance surface 10A in the conveyance direction FD as viewed in the width direction W.

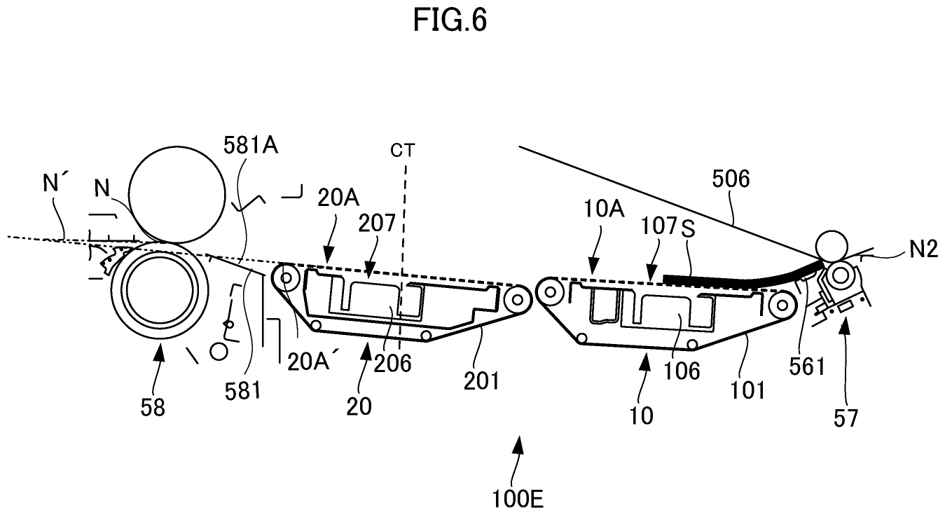

Next, the relationship between the behavior of the sheet in sheet conveyance by the belt conveyance unit 100E and the layout of the opening portions 207A and 207B of the second belt conveyance portion 20 and the opening portions 107A and 107B of the first belt conveyance portion 10 will be described. FIGS. 6 to 8 are each a section view of the secondary transfer portion 57, the belt conveyance unit 100E, and the fixing portion 58. To be noted, in FIGS. 6 to 8, the opening portions 207A and 207B are illustrated as opening portions 207, and the opening portions 107A and 107B are illustrated as opening portions 107. In addition, in FIGS. 6 to 8, the fans 206A and 206B are illustrated as fans 206, and the fans 106A and 106B are illustrated as fans 106.

As illustrated in FIG. 6, a transfer separation guide 561 that separates the conveyed sheet from the secondary transfer nip portion N2 and guides the separated sheet toward the belt conveyance unit 100E is provided between the belt conveyance unit 100E and the secondary transfer nip portion N2 in the conveyance direction FD. In addition, a pre-fixation guide 581 that guides the sheet conveyed by the belt conveyance unit 100E to the fixing nip portion N is provided between the belt conveyance unit 100E and the fixing nip portion N in the sheet conveyance direction FD. The first belt conveyance portion 10 may be disposed at a position below the secondary transfer nip portion N2 as viewed in the sheet width direction W perpendicular to the sheet conveyance direction FD. The second belt conveyance portion 20 may be disposed at a position below the fixing nip portion N as viewed in the sheet width direction W perpendicular to the sheet conveyance direction FD. According to such a configuration, the leading end of the sheet having passed through the secondary transfer nip portion N2 is conveyed toward the first belt conveyance portion 10 along the transfer separation guide 561 as illustrated in FIG. 6. Then, the leading end of the sheet conveyed toward the first belt conveyance portion 10 is attracted toward the conveyance surface 10A in the conveyance direction FD. This is because an airflow toward the opening portions 107 is generated by driving the fans 106.

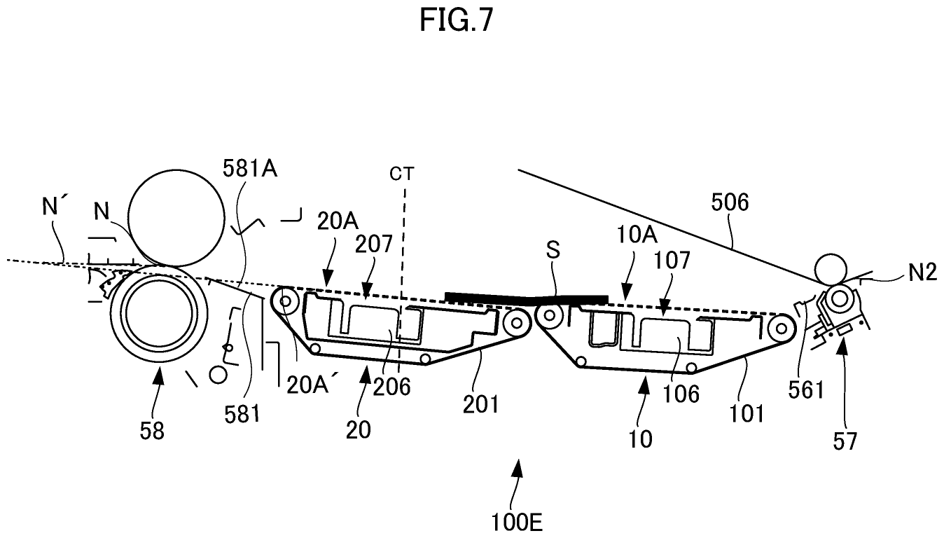

In addition, as viewed in the sheet width direction W perpendicular to the sheet conveyance direction FD, the downstream end of the conveyance surface 10A of the first belt conveyance portion 10 is disposed at a position higher than the upstream end of the conveyance surface 20A of the second belt conveyance portion 20. According to such a layout, the second belt conveyance portion 20 bending the sheet conveyed by the first belt conveyance portion 10 is suppressed as illustrated in FIG. 7. Then, the second belt conveyance portion 20 conveys the sheet received from the first belt conveyance portion 10 toward the fixing portion 58 along the conveyance surface 20A. At this time, the leading end of the sheet conveyed from the first belt conveyance portion 10 is attracted toward the conveyance surface 20A in the conveyance direction FD. This is because an airflow toward the opening portions 207 is generated by driving the fans 206.

In the present embodiment, the centers of the opening portions 207 are disposed downstream of the center of the conveyance surface 20A in the conveyance direction FD indicated by a broken line CT illustrated in FIG. 7, and therefore the leading end of the sheet becomes less likely to be separated from the conveyance surface 20A before reaching the fixing nip portion N. As described above, in the present embodiment, the centers of the opening portions 207 of the second belt conveyance portion 20 disposed the most downstream in the conveyance direction FD among the plurality of belt conveyance portions are disposed downstream of the center of the conveyance surface 20A in the conveyance direction FD indicated by the broken line CT illustrated in FIG. 7. As a result of this, the sheet can be conveyed to the fixing nip portion N in a state in which the leading end of the sheet is more attracted toward the conveyance surface 20A, and therefore occurrence of displacement of the toner image transferred onto sheet or bending of the sheet can be suppressed.

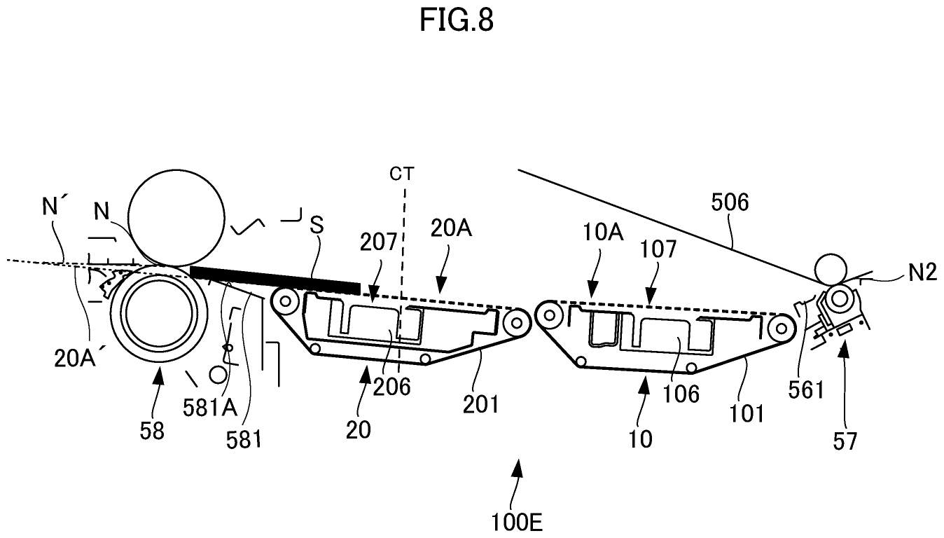

In addition, as illustrated in FIGS. 7 and 8, a virtual line 20A′ extending downstream from the conveyance surface 20A in the sheet conveyance direction FD intersects with a nip line N′ of the fixing nip portion N at a position downstream of the fixing nip portion N in the sheet conveyance direction FD. The nip line N′ of the fixing nip portion N is a tangent that is in contact with the heating roller 582 and the opposing roller 583 among tangents of the fixing nip portion N. According to such a configuration, the sheet conveyed on the conveyance surface 20A is conveyed in a direction intersecting with the nip line N′ from the lower side to the higher side in a state in which separation of the leading end thereof from the conveyance surface 20A is suppressed as illustrated in FIG. 8. Further, the pre-fixation guide 581 serving as a guide member of the present embodiment is provided between the second belt conveyance portion 20 and the fixing portion 58 in the sheet conveyance direction FD. The pre-fixation guide 581 includes a guide surface 581A that guides the leading end of the sheet conveyed on the conveyance surface 20A toward the fixing nip portion N. As viewed in the width direction W perpendicular to the sheet conveyance direction FD, the guide surface 581A of the pre-fixation guide 581 intersects with the virtual line 20A′ of the conveyance surface 20A at a position downstream of the second belt conveyance portion 20 and upstream of the fixing nip portion N. According to such a configuration, the sheet conveyed by the second belt conveyance portion 20 is guided to the fixing nip portion N along the guide surface 581A in a state in which the sheet intersects with the nip line N′ from the lower side to the higher side in FIG. 8 by being guided by the pre-fixation guide 581. To be noted, the nip line N′ of the fixing nip portion N is present in a plane defined by tangents in contact with the heating roller 582 and the opposing roller 583 among tangents of the fixing nip portion N. That is, since the sheet is conveyed to the fixing nip portion N while intersecting with the nip line N′ from the lower side to the higher side in FIGS. 7 and 8, contact between the heating roller 582 and unfixed toner on the sheet can be suppressed.

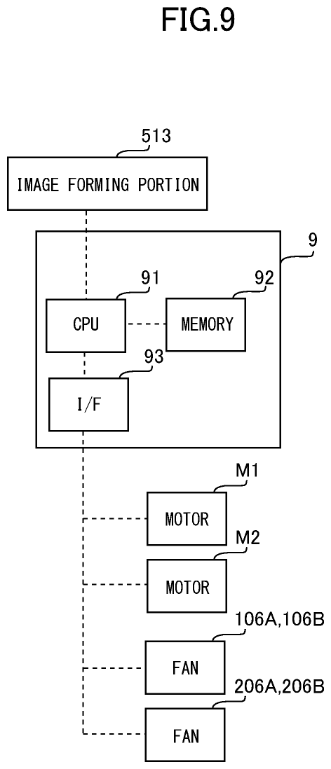

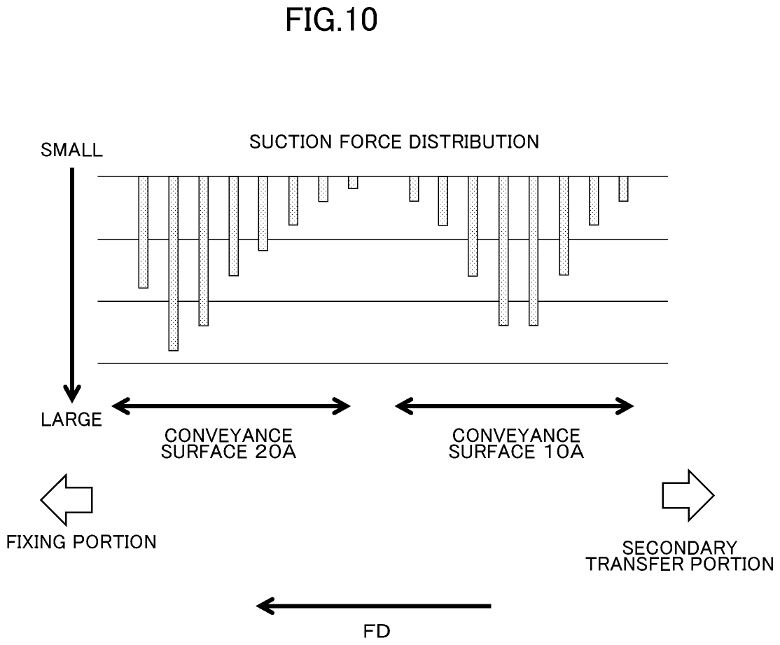

Next, how suction force on the sheet on the conveyance surface 10A and the conveyance surface 20A is distributed will be described with reference to FIGS. 9 and 10. FIG. 9 is a functional block diagram illustrating a control configuration of the image forming apparatus 100. FIG. 10 is a diagram illustrating an example of a suction force distribution on the sheet on the conveyance surface 10A and the conveyance surface 20A. As illustrated in FIG. 9, a controller 9 of the image forming apparatus 100 includes a central processing unit: CPU 91 to be in communication with the image forming portion 513, a memory 92, and an interface: I/F 93. The CPU 91 serving as a calculation portion loads a program of the image forming apparatus 100 stored in the memory 92 or the like, and controls the image forming apparatus 100 by performing calculation in accordance with the loaded program. The CPU 91 outputs signals to the motors M1 and M2, and the fans 106A, 106B, 206A, and 206B through the I/F 93.

FIG. 10 illustrates a distribution of suction force on the sheet on the conveyance surface 10A and the conveyance surface 20A in the case where the driving amounts of the fans 106A, 106B, 206A, and 206B are the same. As illustrated in FIG. 10, the suction force on the sheet on the conveyance surface 10A is approximately equally distributed on the upstream side and the downstream side with respect to the center in the conveyance direction FD. In contrast, the suction force on the sheet on the conveyance surface 20A is larger on the downstream side than on the upstream side in the conveyance direction FD with respect to the center in the conveyance direction FD. This is because the centers of the opening portions 207 are disposed downstream of the center of the conveyance surface 20A in the conveyance direction FD indicated by the broken line CT of FIG. 7, and therefore an airflow toward the opening portions 207 is generated by driving the fans 206. In the present embodiment, the opening portions 207 of the second belt conveyance portion 20 that is a belt conveyance portion disposed the most downstream in the conveyance direction FD are disposed such that the centers of the opening portions 207 are positioned downstream of the conveyance surface 20A. As a result of this, the sheet can be more easily conveyed to the fixing nip portion N such that the leading end of the sheet intersects with the nip line N′ from the lower side to the higher side. Therefore, in the present embodiment, displacement of the toner image and bending of the sheet caused by the contact between the sheet and the heating roller 582 when the sheet enters the fixing nip portion N can be suppressed, and thus the printing quality and the conveyance efficiency of sheets can be simultaneously improved.

### Other Embodiments

Although the image forming portion 513 of a four-color system has been described as an example with reference to FIG. 1, the configuration of the first embodiment can be also applied to printers including other image forming units such as monochromatic image forming units and image forming units of special colors different from C, M, Y, and K. In addition, the configuration of the first embodiment can be also applied to printers of a direct transfer system that directly transfers toner onto a sheet by a primary transfer roller serving as a transfer portion.

In addition, the belt conveyance unit 100E may be constituted by only the second belt conveyance portion 20, that is, may be constituted by just one belt conveyance portion. In addition, the belt conveyance unit 100E may be constituted by three or more belt conveyance portions. In this case, a similar effect to the first embodiment can be obtained by providing a belt conveyance portion having a similar configuration to the second belt conveyance portion 20 as the most downstream belt conveyance portion in the conveyance direction FD.

In addition, the length of the first belt conveyance portion 10 does not have to be equal to the length of the second belt conveyance portion 20 in the conveyance direction FD. A similar effect to the first embodiment can be obtained by providing the opening portions 207 in the second belt conveyance portion 20 such that the centers of the opening portion 207 are positioned downstream of the center of the conveyance surface 20A.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-087087, filed May 19, 2020, which is hereby incorporated by reference herein in its entirety.

What is claimed is:

1. An image forming apparatus comprising:
an image bearing member configured to bear a toner image;
a transfer portion configured to transfer the toner image born on the image bearing member onto a sheet;
a fixing portion configured to fix, to the sheet, the toner image transferred onto the sheet by the transfer portion;
a first belt conveyance portion disposed between the transfer portion and the fixing portion in a sheet conveyance direction, wherein the first belt conveyance portion includes a first stretching portion, a first air suction portion having a first opening portion, and a first conveyance belt having an endless shape and breathability,
wherein the first stretching portion is configured to rotatably stretch the first conveyance belt to form a first conveyance surface on which the sheet is to be conveyed,
wherein the first air suction portion includes a first opening portion open toward the first conveyance surface and provided on a side opposite to the first conveyance surface, wherein the first air suction portion is configured to suck air through the first opening portion to attract the sheet to the first conveyance surface of the first conveyance belt, and
wherein the first belt conveyance portion is configured to convey the sheet by rotating the first conveyance belt while sucking air by the first air suction portion to attract the sheet;
a second belt conveyance portion disposed between the first belt conveyance portion and the fixing portion in the sheet conveyance direction, wherein the second belt conveyance portion includes a second stretching portion, a second air suction portion having a second opening portion, and a second conveyance belt having an endless shape and breathability,
wherein the second stretching portion is configured to rotatably stretch the second conveyance belt to form a second conveyance surface on which the sheet is to be conveyed, wherein the second air suction portion includes a second opening portion open toward the second conveyance surface and provided on a side opposite to the second conveyance surface,
wherein the second air suction portion is configured to suck air through the second opening portion to attract the sheet to the second conveyance surface of the second conveyance belt, and
wherein the second belt conveyance portion is configured to convey the sheet by rotating the second conveyance belt while sucking air by the second air suction portion to attract the sheet; and
a pre-fixation guide portion disposed between the second belt conveyance portion and the fixing portion in the sheet conveyance direction, wherein the pre-fixation guide portion includes a guide surface configured to guide a leading end of the sheet conveyed on the second conveyance surface toward the fixing portion,
wherein, as viewed in a sheet width direction perpendicular to the sheet conveyance direction, a center position of the first opening portion is disposed at approximately the same position as a center position of the first conveyance surface, and a center position of the second opening portion is disposed at a position closer to the pre-fixation guide portion than a center position of the second conveyance surface.

2. The image forming apparatus according to claim 1, wherein, as viewed in the sheet width direction perpendicular to the sheet conveyance direction, an upstream end of the second conveyance surface is positioned below a downstream end of the first conveyance surface.

3. The image forming apparatus according to claim 2,
wherein the transfer portion includes a transfer nip portion configured to nip and convey the sheet, and
wherein, as viewed in the sheet width direction perpendicular to the sheet conveyance direction, an upstream end of the first conveyance surface is positioned below the transfer nip portion.

4. The image forming apparatus according to claim 1,
wherein the fixing portion includes a heating roller configured to heat the sheet, and includes an opposing roller configured to form a fixing nip portion together with the heating roller, where the fixing nip portion is configured to nip and convey the sheet, and
wherein a virtual line extending downstream in the sheet conveyance direction from the second conveyance surface intersects with a nip line at a position downstream of the fixing nip portion in the sheet conveyance direction, where the nip line is a tangent in contact with the heating roller and the opposing roller.

5. The image forming apparatus according to claim 4, wherein the guide surface intersects with the virtual line at a position downstream of the second conveyance belt as viewed in the sheet width direction perpendicular to the sheet conveyance direction.

6. An image forming apparatus comprising:
an image bearing member configured to bear a toner image;
a transfer portion configured to transfer the toner image born on the image bearing member onto a sheet;
a fixing portion configured to fix, to the sheet, the toner image transferred onto the sheet by the transfer portion;
a first belt conveyance portion disposed between the transfer portion and the fixing portion in a sheet conveyance direction, wherein the first belt conveyance portion includes a first stretching portion, a first air suction portion having a first opening portion, and a first conveyance belt having an endless shape and breathability,
wherein the first stretching portion is configured to rotatably stretch the first conveyance belt to form a first conveyance surface on which the sheet is to be conveyed,
wherein the first air suction portion includes a first opening portion open toward the first conveyance surface and provided on a side opposite to the first conveyance surface, wherein the first air suction portion is configured to suck air through the first opening portion to attract the sheet to the first conveyance surface of the first conveyance belt, and
wherein the first belt conveyance portion is configured to convey the sheet by rotating the first conveyance belt while sucking air by the first air suction portion to attract the sheet;
a second belt conveyance portion disposed between the first belt conveyance portion and the fixing portion in the sheet conveyance direction,
wherein the second belt conveyance portion includes a second stretching portion, a second air suction portion having a second opening portion, and a second conveyance belt having an endless shape and breathability, wherein the second stretching portion is configured to rotatably stretch the second conveyance belt to form a second conveyance surface on which the sheet is to be conveyed,
wherein the second air suction portion includes a second opening portion open toward the second conveyance surface and provided on a side opposite to the second conveyance surface, wherein the second air suction portion is configured to suck air through the second opening portion to attract the sheet to the second conveyance surface of the second conveyance belt, and
wherein the second belt conveyance portion is configured to convey the sheet by rotating the second conveyance belt while sucking air by the second air suction portion to attract the sheet; and
a pre-fixation guide portion disposed between the second belt conveyance portion and the fixing portion in the sheet conveyance direction, wherein the pre-fixation guide portion includes a guide surface configured to guide a leading end of the sheet conveyed on the second conveyance surface toward the fixing portion,
wherein, as viewed in a sheet width direction perpendicular to the sheet conveyance direction, a distance between a center position of the first conveyance surface and a center position of the first opening portion is larger than a distance between a center position of the second conveyance surface and a center position of the second opening portion.
